(19) United States
(12) Patent Application Publication
(10) Pub. No.: US 2026/0229706 A1
(43) Pub. Date: Aug. 6, 2026

(54) ELECTRODE ASSEMBLY AND RECHARGEABLE BATTERY INCLUDING THE SAME

(71) Applicant: SAMSUNG SDI CO., LTD., Yongin-si (KR)

(72) Inventors: Min Hee KIM, Suwon-si (KR); Seung Woo LEE, Suwon-si (KR); Sun A. LEE, Suwon-si (KR); Hui Jeong CHO, Suwon-si (KR); Han Woong CHO, Suwon-si (KR)

(73) Assignee: SAMSUNG SDI CO., LTD., Yongin-si (KR)

(21) Appl. No.: 19/455,183

(22) Filed: Jan. 21, 2026

(30) Foreign Application Priority Data
Jan. 31, 2025 (KR) 10-2025-0012548

(51) Int. Cl. H01M 50/46; H01M 10/0587; H01M 50/105

(52) U.S. Cl. CPC H01M 50/461; H01M 10/0587; H01M 50/105

(57) ABSTRACT

The present disclosure relates to an electrode assembly and a battery including the electrode assembly, and describes suppressing a reduction in output and a shortening of usable time at full charge, even when the number of charge-discharge cycles increases due to prolonged use. The electrode assembly has a first electrode plate, a separator, and a second electrode plate that are stacked together and wound so as to have a round area and a flat area, and includes an adhesive member disposed at one or more of an interface between the first electrode plate and the separator and an interface between the second electrode plate and the separator. The adhesive member is interposed in the round area and is not interposed in the flat area.

### CROSS-REFERENCE TO RELATED APPLICATION

The present application claims priority to Korean Patent Application No. 10-2025-0012548, filed on Jan. 31, 2025 in the Korean Intellectual Property Office, the entire disclosure of which is incorporated herein by reference.

### BACKGROUND

### Technical Field

The present disclosure relates to an electrode assembly, and a battery including the electrode assembly.

### Description of the Related Art

Unlike a primary battery that typically cannot be recharged, a rechargeable battery is a battery that can be recharged and discharged. A low-capacity rechargeable battery is typically used in portable small-sized electronic devices, such as, e.g., smartphones, feature phones, notebook computers, digital cameras, and camcorders, and a high-capacity rechargeable battery is widely used as a power source for, e.g., driving a motor in hybrid vehicles and electric vehicles and as a battery for power storage. Such a rechargeable battery includes electrodes including a positive electrode and/or a negative electrode, an electrode assembly including the electrodes, a case that accommodates the electrode assembly, electrode terminals connected to the electrode assembly, and the like.

As technology advances, batteries with high capacity are more advantageous. Accordingly, a plurality of batteries may be electrically connected and used. For example, the batteries may be applicable to an electronic device in the form of a battery module including a plurality of batteries, and/or a battery pack including a plurality of battery modules. According to an example embodiment, the battery pack is also configured by a plurality of batteries. In this case, the electronic device is an electronic device for which high power and/or high capacity are advantageous and includes, for example, an electric vehicle or the like.

In addition, in fields such as electronic devices and electric vehicles, the demand for longer battery lifespan is increasing due to the extended service life of products and environmental concerns related to batteries waste. One of the factors that affects a lifespan of a battery is an increase in internal resistance of the battery caused by a greater number of charge-discharge cycles due to prolonged use. The increase in the internal resistance of a battery not only leads to a reduced output, but also shortens the usable time of the battery when fully charged. Accordingly, a technology to reduce or suppress the increase in the internal resistance of a battery, even when the number of charge-discharge cycles increases with prolonged use, may be advantageous in order to extend the lifespan of the battery.

The above-described information disclosed in the background technology of the present disclosure is merely intended to improve understanding of the background of the present disclosure and thus may include information that does not form the related art.

### SUMMARY

The present disclosure describes an electrode assembly and a battery including the electrode assembly, capable of reducing or minimizing output reduction and a decrease in usable time when fully charged even with prolonged use of the battery.

However, the issues to be addressed in the present disclosure are not limited to the above-mentioned issues, and other issues not mentioned can be clearly understood by those skilled in the art from the following description.

According to an aspect of the present disclosure, an electrode assembly in which a first electrode plate, a separator, and a second electrode plate are stacked and wound so as to have a round area and a flat area. The electrode assembly includes an adhesive member disposed at one or more of an interface between the first electrode plate and the separator and an interface between the second electrode plate and the separator. The adhesive member is provided in the round area.

According to one example embodiment, the adhesive member is not provided in the flat area.

According to another example embodiment, the adhesive member may have one planar shape, and, in a winding core portion of the electrode assembly, a length of the adhesive member may be in a range of about 50% to about 150% of a length of the first electrode plate or the second electrode plate in the round area. In this case, in the winding core portion of the electrode assembly, a width of the adhesive member may be in a range of about 50% to about 150% of a width of the electrode plate having a smaller width among the first electrode plate and the second electrode plate. In addition, the first electrode plate may be or include a positive electrode plate, the second electrode plate may be or include a negative electrode plate, and, in the winding core portion of the electrode assembly, the width of the adhesive member may be in a range of about 50% to about 150% of a width of the first electrode plate.

According to still another example embodiment, the adhesive member may have one planar shape, and, in a winding end portion of the electrode assembly, a length of the adhesive member may be in a range of about 50% to about 100% of a length of the first electrode plate or the second electrode plate in the round area. In addition, in the winding end portion of the electrode assembly, a width of the adhesive member may be in a range of about 50% to about 150% of a width of the electrode plate having a smaller width among the first electrode plate and the second electrode plate.

According to yet another example embodiment, the adhesive member may include a plurality of patterned adhesive portions disposed within an effective adhesive region. In this case, each of, or at least one of, the patterned adhesive portions may have at least one of a line shape and a dot shape. In addition, an area of an actual adhesive region of the plurality of patterned adhesive portions may be in a range of about 50% to about 100% of an area of the effective adhesive region.

According to yet another example embodiment, the adhesive member may include a coating film formed of or including an acrylate-based binder or a polyvinylidene fluoride (PVDF)-based binder.

According to an aspect of the present disclosure, a battery includes an electrode assembly, and a case accommodates the electrode assembly. The electrode assembly has a first electrode plate, a separator, and a second electrode plate that are stacked and wound so as to have a round area and a flat area. The electrode assembly also includes an adhesive member disposed at one or more of an interface between the first electrode plate and the separator, and an interface between the second electrode plate and the separator. The adhesive member is provided in the round area.

According to one example embodiment, the adhesive member is not provided in the flat area.

According to another example embodiment, the adhesive member may have one planar shape, and, in a winding core portion of the electrode assembly, a length of the adhesive member may be in a range of about 50% to about 150% of a length of the first electrode plate or the second electrode plate in the round area. In this case, in the winding core portion of the electrode assembly, a width of the adhesive member may be in a range of about 50% to about 150% of a width of the electrode plate having a smaller width among the first electrode plate and the second electrode plate.

According to still another example embodiment, the adhesive member may have one planar shape, and, in a winding end portion of the electrode assembly, a length of the adhesive member may be in a range of about 50% to about 100% of a length of the first electrode plate or the second electrode plate in the round area.

According to yet another example embodiment, the adhesive member may include a plurality of patterned adhesive portions disposed within an effective adhesive region. In this case, each of, or at least one of, the patterned adhesive portions may have at least one of a line shape and a dot shape. In addition, an area of an actual adhesive region of the plurality of patterned adhesive portions may be in a range of about 50% to about 100% of an area of the effective adhesive region.

According to yet another example embodiment, the adhesive member may include a coating film formed of or including an acrylate-based binder or a polyvinylidene fluoride (PVDF)-based binder.

### BRIEF DESCRIPTION OF THE DRAWINGS

The following drawings appended to the present specification are intended to illustrate example embodiments of the present disclosure, and the spirit of the present disclosure is more clearly understood from the accompanying drawings together with the following description of the disclosure, and thus illustrations in the drawings should not be construed as limiting the scope of the present disclosure, in which:

FIG. 1 is a perspective view schematically illustrating a battery according to one example embodiment;

FIG. 2 is a cross-sectional view schematically illustrating an electrode assembly according to one example embodiment;

FIG. 3 is a photograph showing a widened gap between an electrode plate and a separator in a conventional electrode assembly;

FIG. 4 is a diagram schematically illustrating an adhesive member according to an example embodiment;

FIG. 5 is a diagram schematically illustrating an adhesive member according to another example embodiment; and

FIG. 6A to FIG. 6D are diagrams each schematically illustrating an adhesive member according to still another example embodiment of the present disclosure.

### DETAILED DESCRIPTION

Hereinafter, example embodiments of the present disclosure are described in detail with reference to the accompanying drawings. The terms or words used in the present specification and claims should not be construed as being limited to ordinary or dictionary meanings, and should be construed as meanings and concepts consistent with the technical spirit of the present disclosure based on the principle that an inventor can appropriately define concepts and terms to explain the disclosure. Therefore, the example embodiments described herein and the configuration illustrated in the drawings are only example embodiments, and are not representative of the full the technical spirit of the present disclosure, and thus, it should be understood that various equivalents and modifications may be made at the time of filing the present application.

Further, when used in the present specification, “comprise/include” and/or “comprising/including” may specify the presence of described shapes, numbers, steps, operations, members, elements, and/or groups thereof, and may not exclude the presence or addition of one or more other shapes, numbers, steps, operations, members, elements, and/or groups thereof.

Further, for helping to understand the disclosure, the accompanying drawings may be illustrated such that sizes of some components may be exaggerated for clarity. In addition, the same reference numerals may be assigned to the same components in different embodiments.

The description that two objects for comparison are “the same” as each other may denote that they are “substantially the same” as each other. Thus, the range of the expression “substantially the same” may include a case of having a deviation considered as a low degree, for example, a deviation within 5%. In addition, the description that a certain parameter is the same in a certain region may denote that the parameter is the same from an average perspective.

When the terms “about” or “substantially” are used in this specification in connection with a numerical value, it is intended that the associated numerical value include a tolerance of +5% around the stated numerical value. When ranges are specified, the range includes all values therebetween such as increments of 0.1%.

Terms such as “first” and “second” may be used to describe various components, but the components are not limited by the terms. These terms are merely used to distinguish one component from another. Unless particularly described as the opposite, a first component may also be a second component.

Throughout the specification, unless particularly described otherwise, each component may be provided as a single component or as a plurality of components.

Arrangement of any configuration on an “upper portion” (or lower portion) of a component or “on” (or under) the component may mean not only any configuration may be disposed to be in contact with an upper surface (or lower surface) of the component but also that another configuration may be interposed between the component and any configuration disposed on (or below) the component.

In addition, when a component is described as being “connected,” “coupled,” or “accessed” to another component, the components may be directly connected or accessed to each other, but it should be understood that still another component may be interposed between these components, or these components are “connected”, “coupled” or “accessed” through still another component.

As used herein, the term “and/or” includes any and all combinations of one or more of the associated listed items. Further, when describing example embodiments of the present disclosure, the use of “may” indicates one or more example embodiments of the present disclosure. When preceding a list of elements, the expressions “one or more” and “at least one” modify the entire list of elements and do not modify the individual elements of the list.

The expression “A and/or B” throughout the specification means A, B, or “A and B,” unless otherwise differently stated. The expression “C to D” means “C or more and D or less,” unless otherwise specified.

When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as “A, B, C,” “A and B,” “A and C,” “B and C,” or “A and B and C.”

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is understood that, although the terms “first,” “second,” “third,” and the like, may be used herein to describe various elements, components, regions, layers, and/or sections, these elements, components, regions, layers, and/or sections should not be limited by these terms. These terms are used to distinguish one element, component, region, drawing layer, or cross section from another element, component, region, drawing layer, or cross section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the drawings. It is understood that the spatially relative terms are intended to encompass different orientations of the device in use or operation, in addition to the orientation depicted in the figures. For example, when the device in the drawing is turned over, elements described as “below” or “beneath” other elements would then be oriented “above” or “over” the other elements. Thus, the term “below” may encompass both an orientation of “above” and “below.”

The terms used in the present specification are intended to describe example embodiments of the present disclosure and are not intended to limit the present disclosure.

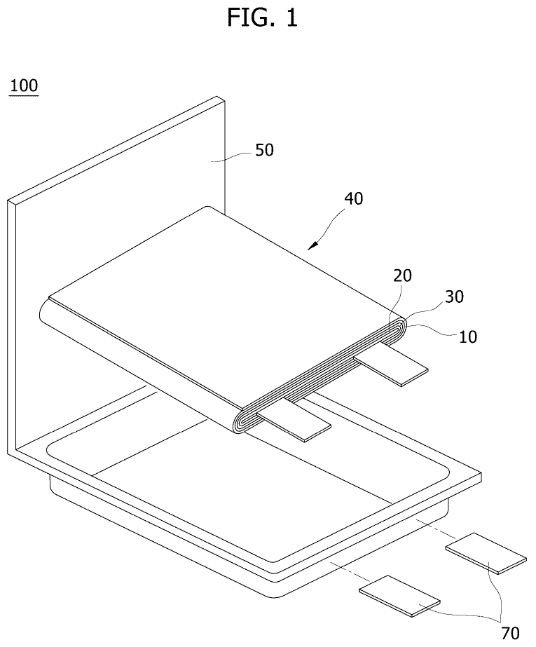

FIG. 1 is a perspective view schematically illustrating a battery according to one example embodiment. Referring to FIG. 1, a battery 100 may include an electrode assembly 40 including a separator 30 interposed between a positive electrode plate (first electrode plate) 10 and a negative electrode plate (second electrode plate) 20, and a case 50 in which the electrode assembly 40 is accommodated. The positive electrode plate 10, the negative electrode plate 20, and the separator 30 may be impregnated with an electrolyte (not shown). In addition, the battery 100 may include electrode tabs 70, that is, a positive electrode tab and a negative electrode tab, which constitute electrical paths for inducing a current formed in the electrode assembly 40 to the outside of the battery 100.

The positive electrode plate 10 may include a current collector and a positive electrode active material layer formed on the current collector. Aluminum (Al) may be used as the current collector, but the present disclosure is not limited thereto. In addition, the positive electrode active material layer includes a positive electrode active material, and may further include a binder and/or a conductive material. A content of the positive electrode active material may range from about 90 wt % to about 99.5 wt % based on 100 wt % of the positive electrode active material layer, and a content of each of, or at least one of, the binder and/or the conductive material may range from about 0.5 wt % to about 5 wt % based on 100 wt % of the positive electrode active material layer. In addition, the positive electrode plate 10 may further include an additive that can constitute a sacrificial positive electrode.

As the positive electrode active material, a compound (lithiated intercalation compound) that is capable of reversible intercalation and deintercalation of lithium may be used. For example, one or more of a composite oxide of lithium and a metal such as or including at least one of cobalt, manganese, nickel, and a combination thereof may be used.

The composite oxide may be or include a lithium-transition metal composite oxide, and examples thereof may include at least one of lithium nickel-based oxide, lithium cobalt-based oxide, lithium manganese-based oxide, lithium iron phosphate-based compound, cobalt-free nickel-manganese-based oxide, or a combination thereof.

As an example, compounds represented by any one of the following chemical formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≥0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8,0.001≤b≤0.1); LiₐMn_{1-g}G_{g}PO₄ (0.90≤a≤1.8,0≤g<0.5); Li_{(3-f)}Fe₂(PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare-earth element or a combination thereof; D is or includes at least one of O, F, S, P, or a combination thereof; G is or includes at least one of Al, Cr, Mn, Fe, Mg, La, Ce, Sr, V, or a combination thereof; and L1 is or includes at least one of Mn, Al, or a combination thereof.

As an example, the positive electrode active material may be or include a high-nickel-based positive electrode active material having a nickel content that is greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of the metal excluding lithium in the lithium-transition metal composite oxide. The high-nickel-based positive electrode active material may be capable of realizing high capacity, and can be applied to high-capacity and high-density rechargeable batteries.

The binder adheres positive electrode active material particles to each other, and adheres the positive electrode active material to the current collector. Representative examples of the binder include at least one of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, an epoxy resin, a (meth)acrylic resin, a polyester resin, nylon, or the like, but the present disclosure is not limited thereto.

The conductive material may impart conductivity to the electrode, and any material that does not cause a chemical change and is electrically conductive may be used in the configured battery. Examples of the conductive material may include a carbon-based material such as at least one of natural graphite, artificial graphite, carbon black, acetylene black, Ketjen black, carbon fibers, carbon nanofibers, or carbon nanotubes; a metal-based material in the form of a metal powder or metal fiber including at least one of copper, nickel, aluminum, silver, or the like; a conductive polymer such as a polyphenylene derivative; or a mixture thereof.

The negative electrode plate 20 includes a current collector and a negative electrode active material layer located on the current collector. The negative electrode current collector may be or include at least one of a copper foil, a nickel foil, a stainless steel foil, a titanium foil, a nickel foam, a copper foam, a polymer substrate coated with a conductive metal, and a combination thereof.

In addition, the negative electrode active material layer includes a negative electrode active material, and may further include a binder and/or a conductive material. For example, the negative electrode active material layer may include about 90 wt % to about 99 wt % of the negative electrode active material, about 0.5 wt % to about 5 wt % of the binder, and about 0 wt % to about 5 wt % of the conductive material.

The negative electrode active material includes at least one of a material that can reversibly intercalate/deintercalate lithium ions, a lithium metal, a lithium metal alloy, a material capable of doping and dedoping lithium, or a transition metal oxide.

The material capable of reversible intercalation and deintercalation of lithium ions is a carbon-based negative electrode active material, and may include, for example, crystalline carbon, amorphous carbon, or a combination thereof. Examples of the crystalline carbon may include graphite such as amorphous, plate shape, flake, spherical shape or fibrous natural graphite or artificial graphite. Examples of the amorphous carbon may include at least one of soft carbon or hard carbon, a mesophase pitch carbonized product, calcined coke, and the like.

The lithium metal alloy may be or include an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

A Si-based negative electrode active material or a Sn-based negative electrode active material may be used as the material capable of doping and dedoping lithium. The Si-based negative electrode active material may include at least one of silicon, a silicon-carbon composite, SiOx (0<x<2), a Si-Q alloy (where, Q is or includes at least one of an alkali metal, an alkaline-earth metal, a Group 13 element, a Group 14 element (excluding Si), a Group 15 element, a Group 16 element, a transition metal, a rare-earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. According to one example embodiment, the silicon-carbon composite may be in the form of silicon particles and amorphous carbon coated on the surface of the silicon particles. For example, the silicon-carbon composite may include a secondary particle (core) in which silicon primary particles are agglomerated, and an amorphous carbon coating layer (shell) located on the surface of the secondary particle. The amorphous carbon may also be located between the silicon primary particles, such that, for example, the silicon primary particles are coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or the Sn-based negative electrode active material may be mixed with a carbon-based negative electrode active material.

The binder adheres negative electrode active material particles to each other, and adheres the negative electrode active material to the current collector. A non-aqueous binder, an aqueous binder, a dry binder, or a combination thereof may be used as the binder.

The non-aqueous binder may include at least one of polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be or include at least one of styrene-butadiene rubber, (meth)acrylated styrene-butadiene rubber, (meth)acrylonitrile-butadiene rubber, (meth)acrylic rubber, butyl rubber, r, fluororubber, a polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenolic resin, an epoxy resin, polyvinyl alcohol, and a combination thereof.

When the aqueous binder is used as the negative electrode binder, a cellulose-based compound capable of imparting viscosity can be further included. As the cellulose-based compound, one or more of carboxymethyl cellulose, hydroxypropylmethyl cellulose, methyl cellulose, or alkali metal salts thereof may be used in combination. At least one of Na, K, or Li can be used as the alkali metal.

The dry binder is or includes a polymer material capable of being fiberized, and may be or include, for example, at least one of polytetrafluoroethylene, polyvinylidene fluoride, a polyvinylidene fluoride-hexafluoropropylene copolymer, a polyethylene oxide, or a combination thereof.

The conductive material may impart conductivity to the electrode, and any material that does not cause an undesirable chemical change, and that is electrically conductive, may be used in the configured battery. Examples of the conductive material may include a carbon-based material such as at least one of natural graphite, artificial graphite, carbon black, acetylene black, Ketjen black, carbon fibers, or carbon nanofibers; a metal-based material in the form of a metal powder or metal fiber including at least one of copper, nickel, aluminum, silver, or the like; a conductive polymer such as a polyphenylene derivative; or a mixture thereof.

The electrolyte includes a non-aqueous organic solvent and a lithium salt.

The non-aqueous organic solvent constitutes a medium through which ions taking part in the electrochemical reaction of a battery can move. The non-aqueous organic solvent may be or include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), ethylmethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethyl alcohol, isopropyl alcohol, and the like. The aprotic solvent may include at least one of nitriles such as R-CN (where R is a C2 to C20 linear, branched, or cyclic hydrocarbon group and includes a double bond, an aromatic ring, or an ether bond, and the like); amides such as dimethyl formamide; dioxolanes such as 1,3-dioxolane and 1,4-dioxolane; sulfolanes; and the like.

The non-aqueous organic solvents may be used alone or in combination of two or more solvents.

In addition, when the carbonate-based solvent is used, a cyclic carbonate and a chain carbonate may be mixed, and the cyclic carbonate and the chain carbonate may be mixed in a volume ratio in a range of about 1:1 to about 1:9.

The lithium salt is a material that dissolves in the organic solvent and constitutes a source of lithium ions in a battery, enables an operation of a rechargeable battery, and prompts the movement of the lithium ions between positive and negative electrodes. Representative examples of the lithium salt may include at least one, or two or more of, LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The separator 30 may be made of or include at least one of polyethylene, polypropylene, polyvinylidene fluoride, or a multilayer film of two or more layers thereof, and may, of course, also be made of or include a mixed multilayer film, such as at least one of a polyethylene/polypropylene double-layered separator, a polyethylene/polypropylene/polyethylene three-layered separator, and a polypropylene/polyethylene/polypropylene three-layered separator.

The separator 30 may include a porous substrate, and a coating layer including an organic material, an inorganic material, or a combination thereof located on one surface, or on both surfaces, of the porous substrate.

The porous substrate may be or include a polymer film formed of or including a polymer, or a copolymer or a mixture of at least two or more of polyolefins such as polyethylene, polypropylene, and the like, polyesters such as polyethylene terephthalate, polybutylene terephthalate, and the like, polyacetal, polyamide, polyimide, polycarbonate, polyetheretherketone, polyaryletherketone, polyetherimide, polyamideimide, polybenzimidazole, polyether sulfone, a polyphenylene oxide, a cyclic olefin copolymer, polyphenylene sulfide, polyethylene naphthalate, glass fibers, Teflon, and polytetrafluoroethylene.

The organic material may include a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic and inorganic materials may be mixed in one coating layer, or may be in the form in which a coating layer including organic materials and a coating layer including inorganic materials are stacked together.

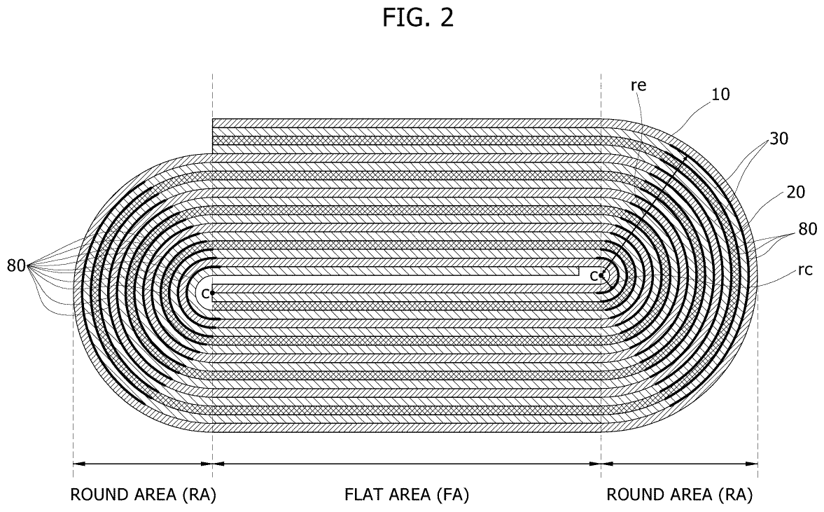

FIG. 2 is a cross-sectional view schematically illustrating the electrode assembly according to one example embodiment. In FIG. 2, components of the electrode assembly, particularly the positive electrode plate 10 and the negative electrode plate 20, are each illustrated as being a single member having a predetermined or desired thickness. However, this is merely a simplified illustration to more clearly depict the technical concept of the example embodiment. Actual cross-sectional shapes of the positive electrode plate 10 and the negative electrode plate 20 may be different from the cross-sectional shapes illustrated in the drawing. For example, the positive electrode plate 10 and the negative electrode plate 20 may each have an active material layer of a predetermined or desired thickness formed on one surface, or on both surfaces, of a substrate, such as a thin foil. In this case, when viewed in a plan view, the active material layer may be formed only on a partial region of the substrate. In addition, the position, area, and the like of the region in which the active material layer is formed may vary depending on the type of battery and/or electrode.

Referring to FIG. 2, the electrode assembly includes the positive electrode plate (first electrode plate) 10, the separator 30, the negative electrode plate (second electrode plate) 20, and the separator 30. In addition, although not shown in the drawings, the electrode assembly may further include a positive electrode tab and a negative electrode tab joined to the positive electrode plate 10 and the negative electrode plate 20, respectively.

The positive electrode plate 10, the negative electrode plate 20, and the separator 30 may each have a rectangular shape in which sizes of a long side and a short side are significantly different. In this case, the size, i.e., a length, of the long side of each of the positive electrode plate 10, the negative electrode plate 20, and the separator 30 (hereinafter, a direction parallel to the long side of each of the positive electrode plate 10, the negative electrode plate 20, or the separator 30 is referred herein to as a “length” direction) is not particularly limited and may be selected as desired in consideration of the type, performance, or the like of a battery including the electrode assembly. In addition, the size, i.e., a width, of the short side of each of the positive electrode plate 10, the negative electrode plate 20, and the separator 30 (hereinafter, a direction parallel to the short side of each of the positive electrode plate 10, the negative electrode plate 20, and the separator 30, which is also parallel to a winding axis, is referred herein to as a “width” direction) is not particularly limited and may be selected as desired in consideration of the type, performance, or the like of a battery including the electrode assembly. However, regarding the width of each of the positive electrode plate 10, the negative electrode plate 20, and the separator 30, the separator 30 may have the greatest width, and the positive electrode plate 10 may have the smallest width. However, the example embodiment described below is not limited thereto.

In addition, the electrode assembly may have a jelly-roll shape in which a stack in which the positive electrode plate 10, the separator 30, the negative electrode plate 20, and the separator 30 are, stacked, e.g., sequentially stacked, is wound multiple times in the length direction. In addition, the jelly roll-shaped electrode assembly, when viewed in a cross-sectional view, may have an elliptical shape, as shown in FIG. 2. Accordingly, the electrode assembly wound in a jelly-roll shape may have a round area RA, and a flat area FA that is substantially planar.

A curvature in the round area RA may vary depending on a distance from a winding axis C. For example, the curvature may be greatest at a center portion of a winding core, i.e., a winding core portion, which is closest to the winding axis C, and gradually decrease toward a winding end portion, which is farthest from the winding axis C.

The electrode assembly may further include an adhesive member 80 interposed at an interface between the positive electrode plate 10 and the separator 30, or at an interface between the negative electrode plate 20 and the separator 30. The adhesive member 80 allows the positive electrode plate 10 or the negative electrode plate 20 to adhere to the separator 30, thereby hindering or preventing the positive electrode plate 10 or the negative electrode plate 20 from detaching from the separator 30 even when the electrode assembly undergoes repeated expansion and contraction due to repeated charging and discharging.

To this end, the adhesive member 80 may be formed of or include a material that exhibits adhesiveness to the positive electrode plate 10, the negative electrode plate 20, and the separator 30. In particular, the adhesive member 80 may be formed of or include a material that exhibits adhesiveness not only to the separator 30 but also to a positive electrode active material layer or a negative electrode active material layer constituting surfaces of the positive electrode plate 10 and the negative electrode plate 20, respectively. For example, the adhesive member 80 may include a coating film formed of or including an acrylate-based binder or a polyvinylidene fluoride (PVDF)-based binder. However, the material of the adhesive member 80 is not limited thereto.

The adhesive member 80 may be disposed at one or more of the interface between the positive electrode plate 10 and the separator 30 and the interface between the negative electrode plate 20 and the separator 30. In FIG. 2, the adhesive member 80 is illustrated as being interposed at both the interface between the positive electrode plate 10 and the separator 30, and the interface between the negative electrode plate 20 and the separator 30, but the present disclosure is not limited thereto. For example, the adhesive member 80 may be interposed only at the interface between the positive electrode plate 10 and the separator 30, or only at the interface between the negative electrode plate 20 and the separator 30.

The adhesive member 80 may be provided in the round area RA of the electrode assembly. That is, the adhesive member 80 may be interposed at the interface corresponding to the round area RA among the interfaces between the positive electrode plate 10, or the negative electrode plate 20, and the separator.

In the case of the electrode assembly wound to have the round area RA and the flat area FA, repeated expansion (swelling) and contraction of the electrode assembly may occur as the number of charge-discharge cycles increases. As a result, a gap may widen between the positive electrode plate 10, or the negative electrode plate 20, and the separator 30. When a gap occurs or the gap increases, interfacial resistance increases, which degrades the performance of the battery and shortens the lifespan of the battery.

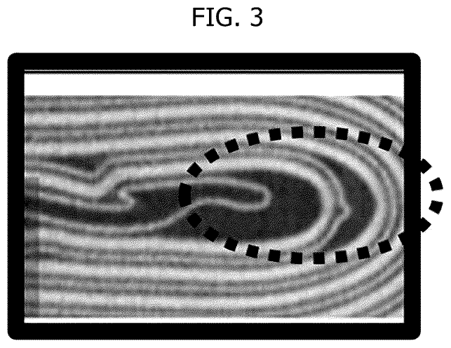

However, as illustrated in FIG. 3, the occurrence and increase of such a gap may occur more frequently and severely in the round area RA than in the flat area FA of the electrode assembly. According to the example embodiment, in the electrode assembly wound to have the round area RA and the flat area FA, the adhesive member 80 is interposed at the interface between the positive electrode plate 10, or the negative electrode plate 20, and the separator 30 in the round area RA, which may reduce, suppress or prevent the occurrence of a gap, or the increase in a size of the formed gap, at least in the round area RA.

Herein, the adhesive member 80 being disposed in the round area RA may mean that an intermediate point of the adhesive member 80 in the length direction is located in the round area RA. Accordingly, the adhesive member 80 does not necessarily have to be positioned across only the round area RA, and a portion of the adhesive member 80 may extend into the flat area FA.

For example, the adhesive member 80 may be entirely, or substantially entirely, positioned across the round area RA, with both end portions in the length direction located within the round area RA. Alternatively, the adhesive member 80 may be partially positioned across the flat area FA, with one or both end portions in the length direction located within the flat area FA. Accordingly, the intermediate point of the adhesive member 80 in the length direction may be located in the round area RA, but a portion of the adhesive member 80 may extend into the flat area FA.

According to one aspect of the example embodiment, the adhesive member 80 may not be disposed in the flat area FA of the electrode assembly. Herein, the adhesive member 80 not being disposed in the flat area FA may mean that not even a portion of the adhesive member 80 extends into the flat area FA. By hindering or preventing the adhesive member 80 from being disposed in the flat area FA as described above, an increase in resistance caused by the adhesive member 80 interposed between the positive electrode plate 10, or the negative electrode plate 20, and the separator 30 can be reduced or minimized.

However, when the adhesive member 80 is interposed between the positive electrode plate 10, or the negative electrode plate 20, and the separator 30, the resistance of the battery including the adhesive member 80 may increase in proportion to an area of a region occupied by the adhesive member 80, which may become a factor in degrading battery performance. Accordingly, the adhesive member 80 may to be interposed at the interface so as to occupy the smallest possible region. However, as described above, when the adhesive member 80 is not interposed in the electrode assembly, a gap may widen between the positive electrode plate 10, or the negative electrode plate 20, and the separator 30, particularly in the round area RA, which may become a factor in increasing resistance. Thus, the adhesive member 80 may be disposed to occupy the greatest possible region in the round area RA so as to reduce or prevent an adhesion loss between the positive electrode plate 10, or the negative electrode plate 20, and the separator 30.

According to the example embodiment, in consideration of the above-described opposing effects related to battery resistance caused by the interposition of the adhesive member 80 at the interface, the size, shape, and the like of the adhesive member 80 disposed on the positive electrode plate 10 or the negative electrode plate 20 may be set as desired. Hereinafter, a more detailed description is provided regarding the above configuration. However, the size, shape, and the like of the adhesive member 80 is described based on the positive electrode plate 10 or the negative electrode plate 20, which adheres to the corresponding adhesive member 80, rather than the separator 30.

In addition, in the round area RA, the length of the positive electrode plate 10 or the negative electrode plate 20 may correspond to the size thereof in the length direction when the positive electrode plate 10 or the negative electrode plate 20 is laid flat. Thus, the length of the positive electrode plate 10 or the negative electrode plate 20 in the round area RA may vary depending on a distance thereof from the winding axis C. Assuming that the round area RA has a generally semicircular shape, the distance from the winding axis C to the positive electrode plate 10 or to the negative electrode plate 20 corresponds to a radius of a circle which circumference is formed by the positive electrode plate 10 or the negative electrode plate 20, and thus, the length of the positive electrode plate 10 or the negative electrode plate 20 in the round area RA may be approximately expressed as radius x circumference ratio (π). Accordingly, the length of the positive electrode plate 10 or the negative electrode plate 20 at the winding core portion is radius (r_{c})× circumference ratio (π), and the length of the positive electrode plate 10 or the negative electrode plate 20 at the winding end portion may be radius (rₑ)× circumference ratio (x).

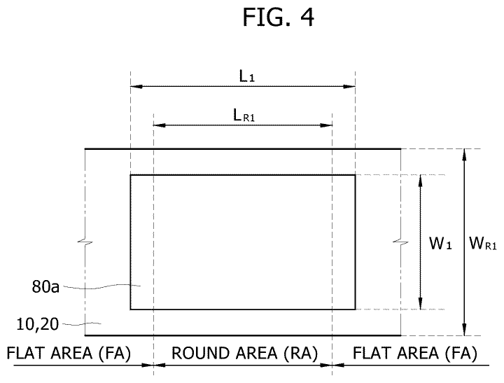

FIG. 4 is a diagram schematically illustrating an adhesive member according to an example embodiment of the present disclosure. In FIG. 4, the positive electrode plate 10 or the negative electrode plate 20, to which an adhesive member 80a is attached, is also illustrated to show the arrangement position and size of the adhesive member 80a. As illustrated in FIG. 4, a planar shape of the adhesive member 80a may be a rectangular shape, which is merely exemplary. For example, the planar shape of the adhesive member 80a may be a circular, elliptical, or polygonal shape.

In addition, FIG. 4 illustrates an unfolded section of the electrode assembly that includes the round area RA at the winding core portion, i.e., at a portion in the first turn closest to the winding axis C (see FIG. 2). However, the unfolded section of the electrode assembly is not limited thereto, and may also correspond to a portion adjacent to the winding core portion, such as a portion in the second or third turn.

Referring to FIG. 4, a length L₁ of the adhesive member 80a may be greater than a length L_{R1} of the positive electrode plate 10 or the negative electrode plate 20 in the round area RA by at least about 50%. Accordingly, in the length direction, the adhesive member 80a may adhere to the separator 30, while covering more than half of the round area RA of the positive electrode plate 10 or the negative electrode plate 20 at the winding core portion.

The above configuration is based on the consideration that, in the winding core portion or portions adjacent thereto, the curvature of the round area RA is relatively large, which increases the likelihood of a gap widening between the positive electrode plate 10, or the negative electrode plate 20, and the separator 30 during repeated expansion and contraction. As illustrated in FIG. 4, when the length L₁ of the adhesive member 80a is set to be 100% or more of the length L_{R1} of the positive electrode plate 10 or the negative electrode plate 20 in the round area RA, the positive electrode plate 10 or the negative electrode plate 20 may adhere to the separator 30 through the adhesive member 80a not only in the round area RA but also in the flat area FA. Thus, the positive electrode plate 10 or the negative electrode plate 20 may more strongly adhere to the separator 30, thereby effectively reducing or suppressing the occurrence of a gap in the round area RA.

However, when the length L₁ of the adhesive member 80a is substantially or excessively long, the increase in internal resistance caused by the adhesive member 80a may degrade battery performance. To this end, the length L₁ of the adhesive member 80a in the winding core portion, or in adjacent portions, of the electrode assembly may be set to, for example, about 150% or less of the length L_{R1} of the positive electrode plate 10 or the negative electrode plate 20 in the round area RA.

In this case, a width W₁ of the adhesive member 80a may be greater than or equal to about 50% of a width W_{R1} of the positive electrode plate 10 or the negative electrode plate 20, for example, within a range of about 50% to about 150%. When the width W₁ of the adhesive member 80a is about 50% or less of the width W_{R1}, adhesion may not be sufficient, which may make it challenging to effectively reduce or prevent the gap between the positive electrode plate 10, or the negative electrode plate 20, and the separator 30 from widening.

Depending on an example embodiment, the width W₁ of the adhesive member 80a may be greater than or equal to about 50% of the width W_{R1} of the electrode plate having a smaller width among the positive electrode plate 10 and the negative electrode plate 20, for example, within a range of about 50% to about 150% of the width W_{R1} of the positive electrode plate 10. Accordingly, since the width remains constant regardless of the type of electrode plate adhered by the adhesive member 80a, productivity may be improved.

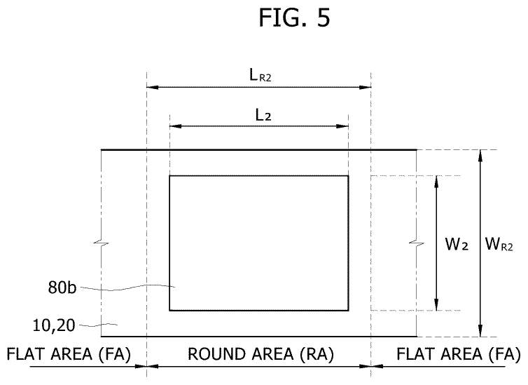

FIG. 5 is a diagram schematically illustrating an adhesive member according to another example embodiment of the present disclosure. Even in FIG. 5, the positive electrode plate 10 or the negative electrode plate 20, to which the adhesive member 80b is attached, is also illustrated to show the arrangement position and size of an adhesive member 80b. As illustrated in FIG. 5, a planar shape of the adhesive member 80b may be a rectangular shape, which is merely an example. For example, the planar shape of the adhesive member 80b may be a circular, elliptical, or polygonal shape.

FIG. 5 illustrates an unfolded section of the electrode assembly that includes the round area RA at the winding end portion, e.g., at a portion in the very last turn furthest from the winding axis C (see FIG. 2). However, the unfolded section of the electrode assembly is not limited thereto, and may also correspond to a portion adjacent to the winding end portion, such as a portion in the second or third turn prior before the last turn.

Referring to FIG. 5, a length L₂ of the adhesive member 80b may be greater than or equal to about 50% and less than or equal to about 100% of a length L_{R2} of the positive electrode plate 10 or the negative electrode plate 20 in the round area RA. Accordingly, in the length direction, the adhesive member 80b may adhere to the separator 30 while covering only a portion of the round area RA of the positive electrode plate 10 or the negative electrode plate 20. However, when the length L₂ of the adhesive member 80b is less than about 50% of the length L_{R2} of the positive electrode plate 10 or the negative electrode plate 20 in the round area RA, adhesion of the adhesive member 80b may not be sufficient, which may fail to reduce or suppress the widening of the gap between the positive electrode plate 10, or the negative electrode plate 20, and the separator 30.

Typically, the curvature of the round area RA is small at the winding end portion or portions adjacent thereto, and thus, even when the length L₂ of the adhesive member 80b is set to be small enough to cover only a portion (e.g., about 50% or more) of the round area RA, the widening of the gap between the positive electrode plate 10, or the negative electrode plate 20, and the separator 30 may be sufficiently reduced or suppressed. In addition, at the winding end portion or portions adjacent thereto, the length L_{R2} of the round area RA is significantly greater than the length at the winding core portion. Thus, by setting a ratio of the length L₂ of the adhesive member 80b to be relatively smaller than the length of the winding core portion, the increase in internal resistance caused by the adhesive member 80b can be reduced or minimized.

In this case, as described with reference to FIG. 4, a width W₂ of the adhesive member 80b may be greater than or equal to about 50% of a width W_{R2} of the positive electrode plate 10 or the negative electrode plate 20, for example, within a range of about 50% to about 150%. When the width W₂ of the adhesive member 80b is 50% or less, adhesion may not be sufficient, which may make it challenging to effectively reduce or prevent the gap between the positive electrode plate 10, or the negative electrode plate 20, and the separator 30 from widening.

Depending on the example embodiment, the width W₂ of the adhesive member 80b may be greater than or equal to about 50% of the width W_{R2} of the electrode plate having a smaller width among the positive electrode plate 10 and the negative electrode plate 20, for example, within a range of about 50% to about 100% of the width W_{R2} of the positive electrode plate 10. Accordingly, since the width remains constant regardless of the type of electrode plate adhered by the adhesive member 80b, productivity may be improved.

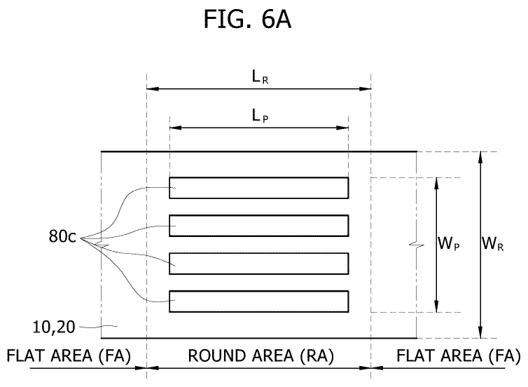

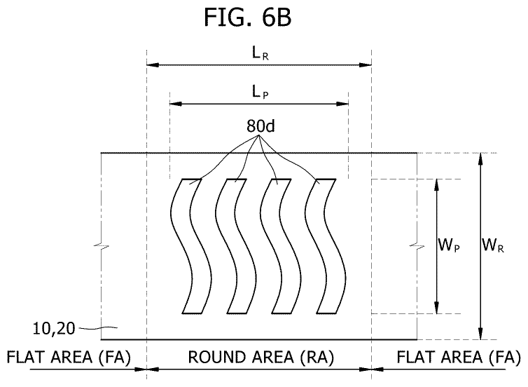

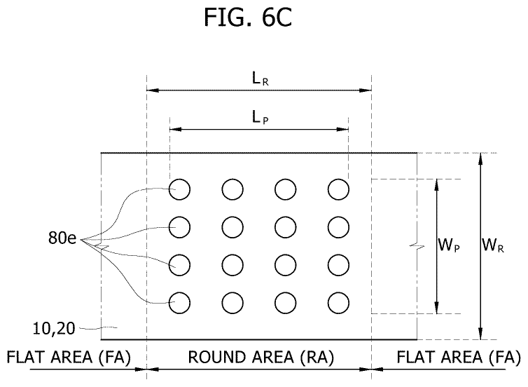

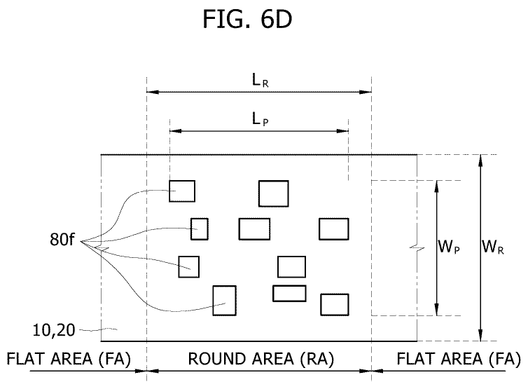

FIG. 6A to FIG. 6D are diagrams each schematically illustrating an adhesive member according to still another example embodiment of the present disclosure. In FIG. 6A to FIG. 6D, the positive electrode plate 10 or the negative electrode plate 20 to which adhesive members 80c to 80f are attached is also illustrated to show the arrangement positions and sizes of the adhesive members 80c to 80f. In addition, in FIG. 6A to FIG. 6D, as shown in FIG. 5, the adhesive members 80c to 80f are illustrated as being disposed only in the round area RA, but the present disclosure is not limited thereto. That is, while the adhesive members 80c to 80f are mostly disposed in the round area RA, some thereof may also be disposed in the flat area FA (see FIG. 4).

Referring to FIG. 6A to FIG. 6D, the adhesive members 80c to 80f are different from the adhesive members 80a and 80b shown in FIG. 4 and FIG. 5, which have a single planar shape, in that a plurality of (two or more) patterned adhesive portions are disposed within a predetermined or desired region, i.e., an effective adhesive region. Herein, the “effective adhesive region” refers to an arbitrary rectangular region in which the patterned adhesive portions forming the adhesive members 80c to 80f may be disposed, and may refer to a region defined based on the outermost patterned adhesive portions (i.e., the adhesive portions located at lower, upper, left, and right sides) of the adhesive members 80c to 80f. Accordingly, as shown in FIG. 6A to FIG. 6D, the effective adhesive region may refer to a rectangular region defined by an “effective length Lp” and an “effective width Wp” of each of the adhesive members 80c to 80f.

As shown in FIG. 6A and FIG. 6B, each of, or at least one of, the patterned adhesive portions disposed in the effective adhesive region may have a line shape, such as a straight line or a curved line. In this case, the patterned adhesive portions may be entirely, or substantially entirely, disposed in the length direction (see FIG. 6A), or entirely, or substantially entirely, disposed in the width direction (see FIG. 6B). However, the patterned adhesive portions are not limited thereto, and may be entirely, or substantially entirely, disposed in a diagonal direction, or may each be disposed in a different direction.

Alternatively, as shown in FIG. 6C and FIG. 6D, each of, or at least one of, the patterned adhesive portions disposed in the effective adhesive region may have a dot shape, such as a circular or rectangular shape. In this case, the dot-shaped patterned adhesive portions may be regularly arranged in the length and/or width direction (see FIG. 6C) or may be randomly arranged (see FIG. 6D).

According to these types of adhesive members 80c to 80f, since a plurality of patterned adhesive portions are dispersed and disposed within the effective adhesive region, an adhesive effect nearly equivalent to the adhesive effect of the adhesive member 80a or 80b with a single planar shape, as shown in FIG. 4 or FIG. 5, can be achieved. In addition, because certain regions within the effective adhesive region do not include the patterned adhesive portions, the increase in resistance caused by the adhesive members 80c to 80f can be reduced.

Within the effective adhesive region, an area of the portion in which the patterned adhesive portions of the adhesive members 80c to 80f are actually attached to the positive electrode plate 10 or the negative electrode plate 20, i.e., an actual adhesive region, may be determined as desired in consideration of maintaining adhesion and reducing or suppressing an increase in resistance caused by the adhesive members 80c to 80f. For example, a ratio of the actual adhesive region of each of, or at least one of, the adhesive members 80c to 80f to a total area of the effective adhesive region, i.e., effective length Lp x effective width Wp, may be greater than or equal to about 50%, for example within a range of about 50% to about 100%. When the ratio is 50% or less, adhesion of the adhesive members 80c to 80f in the effective adhesive region may not be sufficient, and thus, there is a possibility that a gap might occur as the number of charge-discharge cycles increases. On the other hand, when the ratio is 100%, each of the adhesive members 80c to 80f may be substantially the same as the adhesive members 80a or 80b illustrated in FIG. 4 or FIG. 5, since the area of the effective adhesive region is the same as the effective adhesive region of the actual adhesive region.

Table 1 below illustratively shows a size ratio (length and width) of the effective adhesive region of each of the adhesive members 80a to 80f in the round area RA of the positive electrode plate 10 or the negative electrode plate 20, and a battery resistance increase rate according to an area ratio of the actual adhesive region occupied by each of the adhesive members 80a to 80f within the effective adhesive region. Herein, as described above, the adhesive members 80a and 80b illustrated in FIG. 4 and FIG. 5 have the same effective adhesive region and actual adhesive region.

TABLE 1

| | | Width of | Adhesive | | | |
|---|---|---|---|---|---|---|
| | Length of | effective | area ratio | | | |
| | effective | adhesive | (actual | | | |
| | adhesive | region | adhesive | | | |
| | region | (Based | region/ | | | |
| | (based on | on positive | effective | Resistance | Adhesion | |
| | RA | electrode | adhesive | increase | condition at | Battery |
| | length) | plate width) | region) × 100 | rate | round area | lifespan |
| Example 1 | 50% | 100% | 75% | 120% | Adhered | OK |
| Example 2 | 100% | 50% | 75% | 130% | Adhered | OK |
| Example 3 | 100% | 100% | 75% | 150% | Adhered | OK |
| Example 4 | 100% | 100% | 50% | 130% | Adhered | OK |
| Example 5 | 50% | 100% | 100% | 160% | Adhered | OK |
| Example 6 | 100% | 50% | 100% | 160% | Adhered | OK |
| Example 7 | 100% | 100% | 100% | 180% | Adhered | OK |
| Example 8 | 150% | 100% | 75% | 180% | Adhered | OK |
| Comparative | No | No | No | 100% | Poor adhesion | NG |
| Example 1 | Adhesive | Adhesive | Adhesive | | | |
| Comparative | Entire | Entire | Entire | 350% | Adhered | NG |
| Example 2 | length | width | area | | | |
| Comparative | 30% | 50% | 17% | 110% | Poor adhesion | NG |
| Example 3 | | | | | | |
| Comparative | 30% | 100% | 33% | 120% | Poor adhesion | NG |
| Example 4 | | | | | | |
| Comparative | 50% | 50% | 25% | 110% | Poor adhesion | NG |
| Example 5 | | | | | | |
| Comparative | 150% | 30% | 45% | 150% | Poor adhesion | NG |
| Example 6 | | | | | | |
| Comparative | 180% | 50% | 90% | 260% | Adhered | NG |
| Example 7 | | | | | | |
| Comparative | 180% | 30% | 60% | 240% | Adhered | NG |
| Example 8 | | | | | | |

In Table 1, the resistance increase rate and a battery lifespan were each measured and evaluated using the following methods.

### Evaluation 1: Resistance Increase Rate (Measured by Electrochemical Impedance Spectroscopy (EIS))

Separators to which the adhesive members were attached were prepared, wherein the adhesive members had the effective adhesive regions and the adhesive area ratios corresponding to Examples 1 to 8 and Comparative Examples 1 to 8 listed in Table 1 above, respectively. Each of the separators was impregnated with an electrolyte (1.3M LiPF₆ in EC/PC/EP/PP (10/15/30/45)), inserted into a lead-tab-attached aluminum foil electrode, and sealed in an aluminum pouch to prepare a test cell, and a resistance (Ω) of the test cell was measured at 20° C. using an AC impedance method (a measurement frequency of 100 kHz).

The resistance increase rate (%) of the separator of Example 1 was calculated using Equation 1 below, in comparison with Comparative Example 1 (the separator to which the adhesive member is not attached). In addition, the resistance increase rates (%) of Examples 2 to 8 and Comparative Examples 2 to 8 were calculated by substituting the respective resistance values of Examples 2 to 8 and Comparative Examples 2 to 8 into Equation 1, instead of the resistance value of Example 1, and the results are shown in Table 1 above.

$$Resistance increase rate ( \% ) of Example 1 = [ Resistance of Example 1 ( Ω ) / \\ Resistance of Comparative Example 1 ( Ω ) ] \times 100 \qquad Equation 1$$

### Evaluation 2: Battery Lifespan Evaluation

Separators to which the adhesive members were attached were prepared, wherein the adhesive members had the effective adhesive regions and the adhesive area ratios corresponding to Examples 1 to 8 and Comparative Examples 1 to 8, respectively. In addition, a positive electrode slurry was prepared by mixing 97 wt % of a lithium cobalt nickel aluminum-based oxide as a positive electrode active material, 1.5 wt % of carbon nanotubes as a conductive material, and 1.5 wt % of polyvinylidene fluoride with N-methyl-2-pyrrolidone, and then the positive electrode slurry was applied to an aluminum foil, dried, and rolled to prepare a positive electrode. In addition, a negative electrode slurry was prepared by mixing 97.4 wt % of graphite as a negative electrode active material, 1.0 wt % of carboxymethyl cellulose, 1.5 wt % of styrene-butadiene rubber, and 0.1 wt % of carbon nanotubes as a conductive material, and then the negative electrode slurry was applied to a copper foil, dried, and rolled to prepare a negative electrode. In addition, one separator from each of Examples 1 to 8 and Comparative Examples 1 to 8 was positioned between the positive electrode and the negative electrode to form a positive electrode-separator-negative electrode stack, and three (3) such stacks were prepared and placed into a pouch. 2.5 g of an electrolyte (1.5 M LiPF₆ dissolved in a mixed solvent of ethylene carbonate, ethyl methyl carbonate, and dimethyl carbonate in a volume ratio of 30:50:20) was injected into a pouch, after which the pouch was left to stand at 25° C. for 12 hours, and then placed in an oven at 150° C. for 1 hour to manufacture a battery. The manufactured battery was subjected to repeated charge and discharge cycles until the number of cycles at which the state of health (SOH) remained at 80% was reached. A lifespan was evaluated based on whether the number of charge and discharge cycles exceeded 1,300 cycles.

Referring to Table 1 above, when the length of the effective adhesive region is in the range of 50% to 150% of the length of the positive electrode plate 10 or the negative electrode plate 20 in the round area RA, and the width of the effective adhesive region is in the range of 50% to 100% based on the width of the electrode plate (e.g., Examples 1 to 8), adhesion is maintained even when the resistance of the separator increases, thereby maintaining or improving the battery lifespan (OK), but, when the values fall outside these ranges (Comparative Examples 1 to 4, 7, and 8), the adhesive area may be excessively large, resulting in a significant increase in the resistance of the separator itself, or excessively small, leading to poor adhesion in the round area of the electrode assembly, both of which reduce the battery lifespan (NG). It can also be seen that when the ratio of the area of the actual adhesive region to the area of the effective adhesive region falls outside the range of 50% to 100% (e.g., Comparative Examples 3 to 6), the reduced adhesion of the adhesive member 80 leads to an increase in internal resistance of the battery, thereby shortening the battery lifespan (NG).

According to an example embodiment of the present disclosure, even when the number of charge-discharge cycles increases due to prolonged use of a battery, an increase in internal resistance of the battery can be reduced, suppressed or prevented by reducing or preventing the formation of a gap between an electrode and a separator in a curved portion of the jelly-roll-type electrode assembly, thereby prolonging a lifespan of the battery.

However, it is appreciated by persons skilled in the art that the effects that can be achieved through the present disclosure are not limited to the example embodiments described hereinabove, and other advantages of the present disclosure are more clearly understood from the following detailed description.

While the present disclosure has been described with reference to the example embodiments illustrated in the accompanying drawings, it should be understood that the disclosure is not limited to the disclosed example embodiments, but is intended to cover various modifications and equivalent arrangements included within the sprit and scope of the appended claims.

Accordingly, the scope of the present disclosure shall be determined only according to the attached claims.

What is claimed is:

1. An electrode assembly comprising:
a first electrode plate, a separator, and a second electrode plate stacked and wound so as to have a round area and a flat area, and
an adhesive member disposed at one or more of an interface between the first electrode plate and the separator and an interface between the second electrode plate and the separator,
wherein the adhesive member is in the round area.

2. The electrode assembly of claim 1, wherein the adhesive member is not in the flat area.

3. The electrode assembly of claim 2, wherein:
the adhesive member has one planar shape, and
in a winding core portion of the electrode assembly, a length of the adhesive member is in a range of about 50% to about 150% of a length of the first electrode plate or the second electrode plate in the round area.

4. The electrode assembly of claim 3, wherein, in the winding core portion of the electrode assembly, a width of the adhesive member is in a range of about 50% to about 150% of a width of the electrode plate that is a smaller width among the first electrode plate and the second electrode plate.

5. The electrode assembly of claim 4, wherein:
the first electrode plate is a positive electrode plate,
the second electrode plate is a negative electrode plate, and
in the winding core portion of the electrode assembly, the width of the adhesive member is in a range of about 50% to about 150% of a width of the first electrode plate.

6. The electrode assembly of claim 2, wherein:
the adhesive member has one planar shape, and
in a winding end portion of the electrode assembly, a length of the adhesive member is in a range of about 50% to about 100% of a length of the first electrode plate or the second electrode plate in the round area.

7. The electrode assembly of claim 6, wherein, in the winding end portion of the electrode assembly, a width of the adhesive member is in a range of about 50% to about 150% of a width of the electrode plate having a smaller width among the first electrode plate and the second electrode plate.

8. The electrode assembly of claim 2, wherein the adhesive member comprises a plurality of patterned adhesive portions disposed within an effective adhesive region.

9. The electrode assembly of claim 8, wherein at least one of the patterned adhesive portions has at least one of a line shape and a dot shape.

10. The electrode assembly of claim 8, wherein an area of an actual adhesive region of the plurality of patterned adhesive portions is in a range of about 50% to about 100% of an area of the effective adhesive region.

11. The electrode assembly of claim 1, wherein the adhesive member comprises a coating film comprising one of an acrylate-based binder and a polyvinylidene fluoride (PVDF)-based binder.

12. A battery comprising:
an electrode assembly; and
a case accommodating the electrode assembly,
wherein the electrode assembly has a first electrode plate, a separator, and a second electrode plate that are stacked and wound so as to have a round area and a flat area, and includes an adhesive member disposed at one or more of an interface between the first electrode plate and the separator and an interface between the second electrode plate and the separator, and
wherein the adhesive member is in the round area.

13. The battery of claim 12, wherein the adhesive member is not in the flat area.

14. The battery of claim 13, wherein:
the adhesive member has one planar shape, and
in a winding core portion of the electrode assembly, a length of the adhesive member is in a range of about 50% to about 150% of a length of one of the first electrode plate and the second electrode plate in the round area.

15. The battery of claim 14, wherein, in the winding core portion of the electrode assembly, a width of the adhesive member is in a range of about 50% to about 150% of a width of the electrode plate having a smaller width among the first electrode plate and the second electrode plate.

16. The battery of claim 13, wherein:
the adhesive member has one planar shape, and
in a winding end portion of the electrode assembly, a length of the adhesive member is in a range of about 50% to about 100% of a length of one of the first electrode plate and the second electrode plate in the round area.

17. The battery of claim 13, wherein the adhesive member comprises a plurality of patterned adhesive portions disposed within an effective adhesive region.

18. The battery of claim 17, wherein at least one of the patterned adhesive portions has at least one of a line shape and a dot shape.

19. The battery of claim 17, wherein an area of an actual adhesive region of the plurality of patterned adhesive portions is in a range of about 50% to about 100% of an area of the effective adhesive region.

20. The battery of claim 12, wherein the adhesive member comprises a coating film comprising one of an acrylate-based binder and a polyvinylidene fluoride (PVDF)-based binder.
